(19) United States
(12) Patent Application Publication
(10) Pub. No.: US 2003/0041251 A1
(43) Pub. Date: Feb. 27, 2003

(54) Rule-compliant password generator

(75) Inventor: David Bruce Kumhyr, Austin, TX (US)

Correspondence Address: PAUL D. HEYDON, PATENT ATTORNEY, 909 NE LOOP 410, SUITE 300, SAN ANTONIO, TX, 78209, US

(73) Assignee: International Business Machines Corporation, Armonk, NY (US)

(21) Appl. No.: 09/935,416

(22) Filed: Aug. 23, 2001

(51) Int. Cl. H04L 9/00

(52) U.S. Cl. 713/184; 713/182; 713/202; 380/44

(57) ABSTRACT

The invention generates a password, by receiving an easily-remembered preferred word from a user, translating said preferred word to produce a password, and providing said password to an application (i.e. a program or function such as voice mail, e-mail, online banking, etc.). The preferred word is not stored, the password is not stored, and the password complies with the application's required password format. One aspect of the present invention is a method for generating a password. Another aspect of the present invention is a system for executing the method of the present invention. A third aspect of the present invention is as a set of instructions on a computer-usable medium, or resident in a computer system, for executing the method of the present invention.

### FIELD OF THE INVENTION

The present invention relates generally to computer security, and more particularly to methods and systems to generate passwords.

### BACKGROUND OF THE INVENTION

Some approaches to generating passwords have been proposed in the past. Examples include Password Tracker Deluxe, a software product from Roth and Cannalte Software Inc., that stores and manages passwords. Another example is Whisper 32, a software product authored by Shaun Ivory; it also stores and manages passwords. However, the above-mentioned examples address substantially different problems (problems of secure password storage), and thus are significantly different from the present invention.

Users of communications and computer technology typically use multiple password-protected systems, and thus are required to remember (or write down) multiple passwords. On some systems, passwords must be changed from time to time, or passwords must conform to format rules. These security features make life more difficult for unauthorized persons and authorized users alike. Passwords that are easily remembered may be guessed by an unauthorized person who attacks the system, perhaps using a computer and databases containing large numbers of words. Passwords that are written down, or stored on the user's computer, may be found and used by an unauthorized person.

Thus there is a need for systems and methods that generate passwords for an authorized user, wherein passwords are not stored, and passwords comply with required password formats.

### SUMMARY OF THE INVENTION

The invention generates a password, by receiving an easily-remembered preferred word from a user, translating said preferred word to produce a password, and providing said password to an application (i.e. a program or function such as voice mail, e-mail, online banking, etc.). The preferred word is not stored, the password is not stored, and the password complies with the application's required password format.

The invention has the advantage of ease of use for the authorized user (starting with an easily-remembered preferred word), and preserves security measures (the password is not stored, and does not need to be written down). The invention may be used with a wide variety of systems and software. No special hardware is required, although some implementations may use special hardware such as a smart card and reader.

For example, the invention may be implemented in a way that emphasizes ease of use for the authorized user, wherein the translating includes substituting a character for another character. The resulting password may be similar to the user's preferred word. This way, the user might be able to remember the resulting password, and be able to enter the password directly sometimes, without using the generator. On the other hand, the invention may be implemented in a way that emphasizes security. For example, the translating may include encrypting the user's preferred word with an encryption algorithm that does not yield a password similar to the user's preferred word. As another example, the invention may involve inserting at least one special character into the user's preferred word, such that the resulting password may not be easily predictable.

### BRIEF DESCRIPTION OF THE DRAWINGS

A better understanding of the present invention can be obtained when the following detailed description is considered in conjunction with the following drawings. The use of the same reference symbols in different drawings indicates similar or identical items.

FIG. 1 illustrates a simplified example of an information handling system that may be used to practice the present invention.

FIG. 2 is a high- level block diagram illustrating an example of a system for generating a password, according to the teachings of the present invention.

FIG. 3 is a flow chart illustrating an exemplary process for generating a password, according to the teachings of the present invention.

FIG. 4 is a diagram illustrating an example of a user interface that could be used for a system or process for generating a password, according to the teachings of the present invention.

FIG. 5 is a block diagram illustrating a network and examples of features that may be included in a system or process for generating a password, according to the teachings of the present invention.

FIG. 6 is a diagram illustrating an example involving a first computer and a second computer, according to the teachings of the present invention.

FIG. 7 is a diagram illustrating an example involving a smart card, according to the teachings of the present invention.

### DETAILED DESCRIPTION

The examples that follow involve the use of computers and a network. The present invention is not limited as to the type of computer on which it runs, and not limited as to the type of network used. Various implementation methods may be used for the present invention. The examples that follow involve information that is communicated between computers; this information could be in hypertext markup language (HTML), or extensible markup language (XML), or some other language or protocol could be used.

The following are definitions of terms used in the description of the present invention and in the claims: “Application” means any program or function including voice mail, e-mail, online banking, accounting software, or a web site function. “Computer-usable medium” means any carrier wave, signal or transmission facility for communication with computers, and any kind of computer memory, such as floppy disks, hard disks, Random Access Memory (RAM), Read Only Memory (ROM), CD-ROM, flash ROM, non-volatile ROM, and non-volatile memory. “Storing” data or information “stored”, using a computer, means placing the data or information, for any length of time, in any kind of computer memory, such as floppy disks, hard disks, Random Access Memory (RAM), Read Only Memory (ROM), CD-ROM, flash ROM, non-volatile ROM, and non-volatile memory.

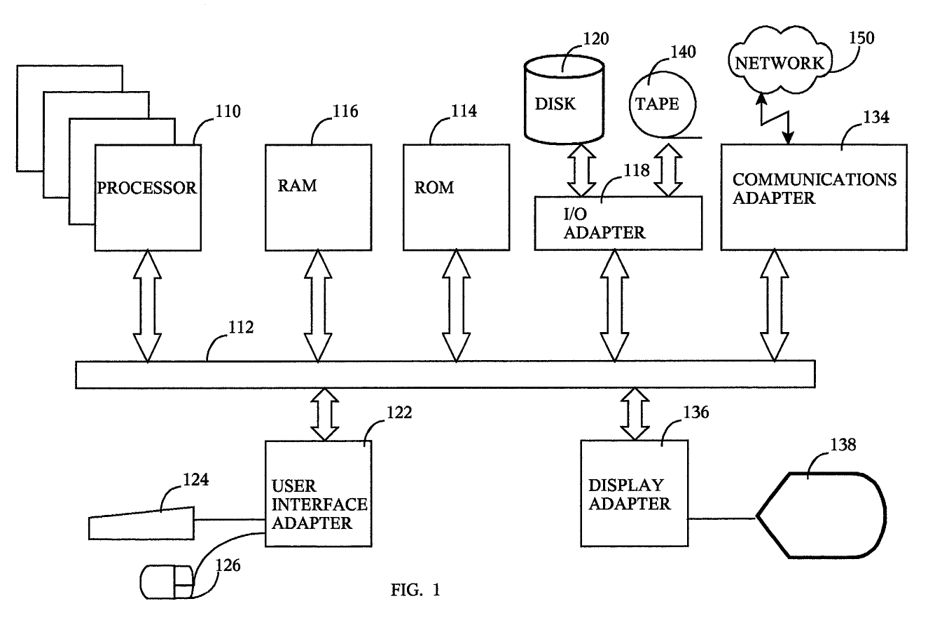

FIG. 1 illustrates a simplified example of an information handling system that may be used to practice the present invention. The invention may be implemented on a variety of hardware platforms, including handheld computers, personal computers, workstations, servers, and embedded systems. The computer system of FIG. 1 has at least one processor 110. Processor 110 is interconnected via system bus 112 to random access memory (RAM) 116, read only memory (ROM) 114, and input/output (I/O) adapter 118 for connecting peripheral devices such as disk unit 120 and tape drive 140 to bus 112, user interface adapter 122 for connecting keyboard 124, mouse 126 or other user interface devices to bus 112, communication adapter 134 for connecting the information handling system to a data processing network 150, and display adapter 136 for connecting bus 112 to display device 138. Communication adapter 134 may link the system depicted in FIG. 1 with hundreds or even thousands of similar systems, or other devices, such as remote printers, remote servers, or remote storage units. The system depicted in FIG. 1 may be linked to both local area networks (sometimes referred to as Intranets) and wide area networks, such as the Internet.

While the computer system described in FIG. 1 is capable of executing the processes described herein, this computer system is simply one example of a computer system. Those skilled in the art will appreciate that many other computer system designs are capable of performing the processes described herein.

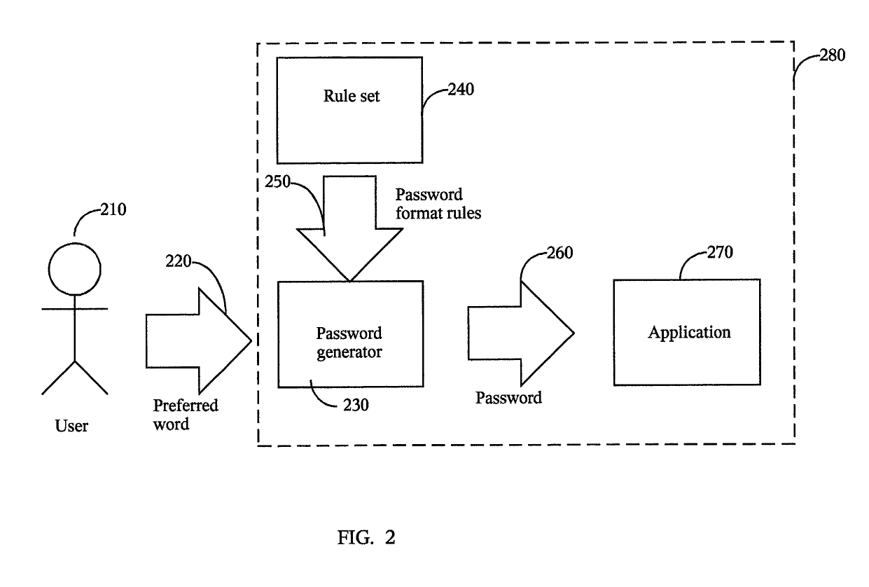

FIG. 2 is a high- level block diagram illustrating an example of a system for generating a password, according to the teachings of the present invention. FIG. 2 shows password generator 230, receiving a preferred word 220, from a user 210. Password generator 230 also receives, 250, password format rules based on rule set 240. Rule set 240 may represent a database of format rules. Password generator 230 translates the preferred word to produce a password, and provides, 260, the password to a target application 270. Thus the preferred word is not stored, the password is not stored, and the password complies with application 270's required password format. A variety of algorithms may be used by password generator 230. However, the output at 260 will be consistent with repeated use; the same input at 220 will result in the same output at 260 time after time. An optional feature may allow user 210 to continue the same input at 220, but to direct a change in the algorithm used by password generator 230, and thus change the output at 260, when a password needs to be changed.

As indicated by the dashed line, the components password generator 230, rule set 240, and target application 270 may be incorporated into one computer system 280, or these components may be incorporated into separate computer systems independent of, but accessible to, one another. In a case where these components are incorporated into one computer system 280, said translating is accomplished by software running on the same computer as said target application 270.

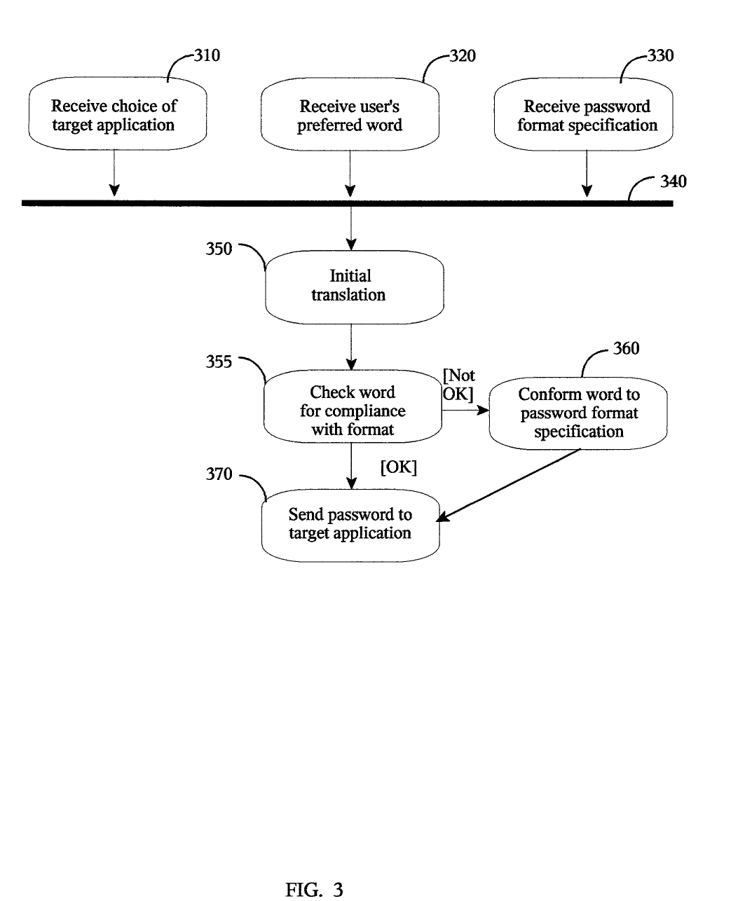

FIG. 3 is a flow chart illustrating an exemplary process for generating a password, according to the teachings of the present invention. At block 310, the password generator receives the user's choice of a target application. At block 320, the password generator receives the user's preferred word. At block 330, the password generator receives the password format specification. Examples are given below to show ways of receiving inputs from a user, specifying a target application, specifying a password format, and specifying a preferred word. Synchronization bar 340, according to the notation of Unified Modeling Language (UML), shows that the processes in blocks 310, 320 and 330 may be performed concurrently, or in any order, and that in this example, block 350, initial translation of the user's preferred word, follows the processes in blocks 310, 320 and 330.

Initial translation of the user's preferred word, block 350, may be implemented in various ways. The invention may be implemented in a way that emphasizes ease of use for the authorized user. For example, the translating may include substituting a character for another character. If desired, the result may be a password that is similar to the user's preferred word. In that case, initial translation of the user's preferred word, block 350, may involve only substituting a character for another character. As an example of substituting numerals for letters, a preferred word, “BIGBLUE,” could be changed to “B1GB1UE.” As an example of substituting special characters for letters, a preferred word, “Porsche,” could be changed to “Por$che.” Here, the special character “$” is substituted for the letter “s.” Any special character that is recognizable by the target application could be used.

On the other hand, the invention may be implemented in a way that emphasizes security. For example, the translating may include encrypting a user's preferred word with an encryption algorithm that does not yield a password similar to the user's preferred word. In that case, initial translation of the user's preferred word, block 350, may involve an encryption algorithm with an appropriate degree of security. Some examples of encryption algorithms that may be appropriate are Blowfish, Data Encryption Standard (DES), International Data Encryption Algorithm (IDEA), RC2, and RC4. Regarding encryption, reference is made to the book by Bruce Schneier, Applied Cryptography: Protocols, Algorithms, and Source Code in C, 2nd Edition, Wiley, 1996.

As another example of how the invention may be implemented in a way that emphasizes security, initial translation of the user's preferred word, block 350, may involve inserting at least one special character. Thus the resulting password may not be easily predictable. For example, a preferred word, “BIGBLUE,” could be changed to “BI*GB/LUE.” Again, any special character that is recognizable by the target application could be used.

At block 355, the password generator checks the word for compliance with the password format specification. If the word complies with the password format specification, then the “OK” branch is taken to block 370. At block 370, the password generator sends the password to the target application. This may involve finding or starting the target application, and submitting the password to the target application.

On the other hand, if the word does not comply with the password format specification, then the “Not OK” branch is taken to block 360. At block 360, the password generator conforms the word to the password format specification. For example, the number of characters may need to be adjusted, or special characters may need to be inserted; this depends on the required password format. At block 370, the password generator sends the password to the target application.

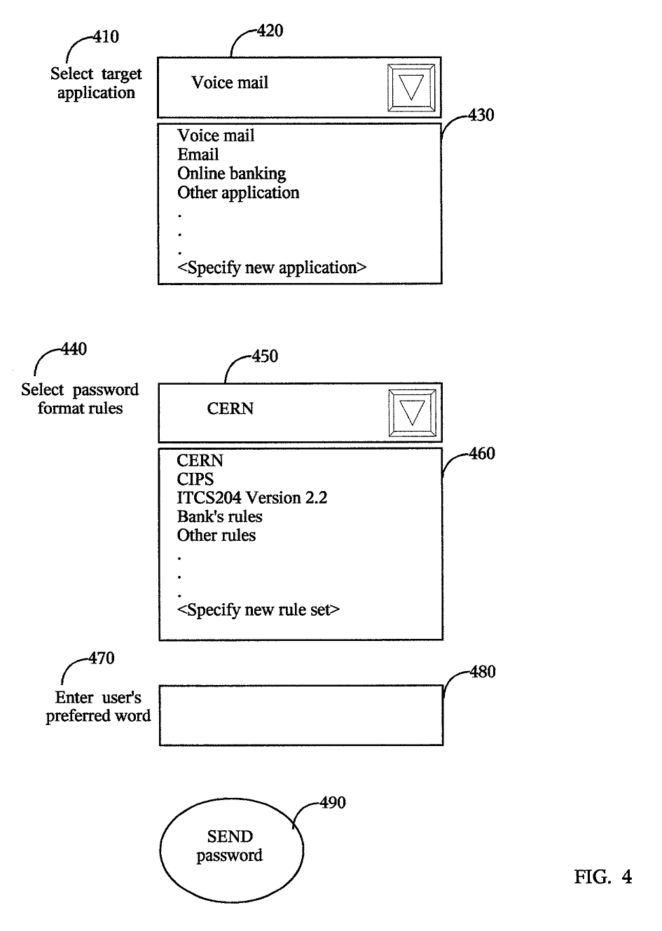

FIG. 4 is a diagram illustrating an example of a user interface that could be used for a system or process for generating a password, according to the teachings of the present invention. This example shows a way of receiving inputs from a user, specifying a target application, specifying a password format, and specifying a preferred word. Menus could be displayed with text and graphics, as shown in FIG. 4. An audible menu also could be provided to the sender via audio output. Spoken input also could be received from the sender via a speech recognition interface, or the sender might mark a word displayed on a screen. A user may choose an option from a menu; thus a menu entry selection signal is received from the user.

At the top left in FIG. 4 is a request, 410, for input to specify a target application. Block 420 shows a target application that the user has specified; in this example, the target application is voice mail. Menu 430 is a list of possible target applications. Ellipses “. . . ” in menu 430 indicate that all possible menu items are not shown in FIG. 4; various other applications could be listed in menu 430. A user may specify a new application that is not named on menu 430; thus a menu item to “specify new application” is shown. Menu 430 may be in the form of a drop-down list that is displayed in response to a user's action, such as a voice command, keystroke combination, or clicking on an item such as the arrowhead in block 420.

At 440 is a request for input to specify a password format. In response to this input, the password generator may retrieve rules from a database of format rules. Block 450 shows a password format that the user has specified; in this example, the password format is “CERN,” referring to a format from the Swiss supercomputing high energy physics center. Menu 460 is a list of possible password formats. Ellipses “. . . ” in menu 460 indicate that all possible menu items are not shown in FIG. 4; various other password formats could be listed in menu 460. A user may specify a new password format that is not named on menu 460; thus a menu item to “specify new rule set” for a password format is shown. This would allow a user to add a new rule set to a database of format rules. Menu 460 may be in the form of a drop-down list that is displayed in response to a user's action, such as a voice command, keystroke combination, or clicking on an item such as the arrowhead in block 450.

At 470 is a request for input to specify a preferred word. Block 480 is shown as one way to receive input of a preferred word. When a user is satisfied with the above-mentioned inputs, a user may start the core functions of translating said preferred word to produce a password, and providing said password for use by said target application. Button 490, marked “SEND password,” is shown as one way to start the core functions; some other user's action, such as a voice command or keystroke combination, may be used.

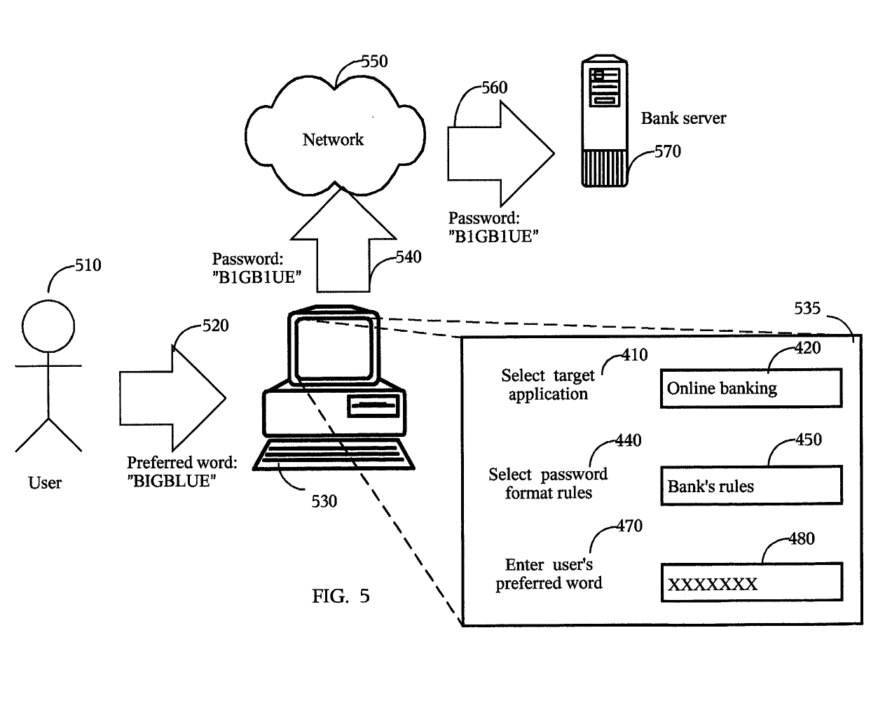

FIG. 5 is a block diagram illustrating a network and examples of features that may be included in a system or process for generating a password, according to the teachings of the present invention. Through computer 530 and user interface 535, the password generator receives a preferred word, “BIGBLUE,” at 520, from a user 510. The password generator also receives password format rules based on a rule set. Thus, the password complies with the target application's required password format. In user interface 535 is a request, 410, for input to specify a target application. Block 420 shows a target application that the user has specified; in this example, the target application is online banking. At 440 is a request for input to specify a password format. Block 450 shows a password format that the user has specified; in this example, the password format is the “Bank's rules” for online banking. At 470 is a request for input to specify a preferred word. Block 480 is shown as one way to receive input of a preferred word (In this example, the preferred word is not echoed; rather, a string of “X's” are shown in block 480). The password generator translates the preferred word to produce a password, and via network 550 provides, 540 and 560, the password “B1GB1UE” to an application running on bank server 570. In this example, the means for translating runs on a first computer, and the target application runs on a second computer. In this example, translating includes substituting numerals for letters, and said password is similar to said preferred word. As an alternative, the means for translating may include means for encrypting said preferred word.

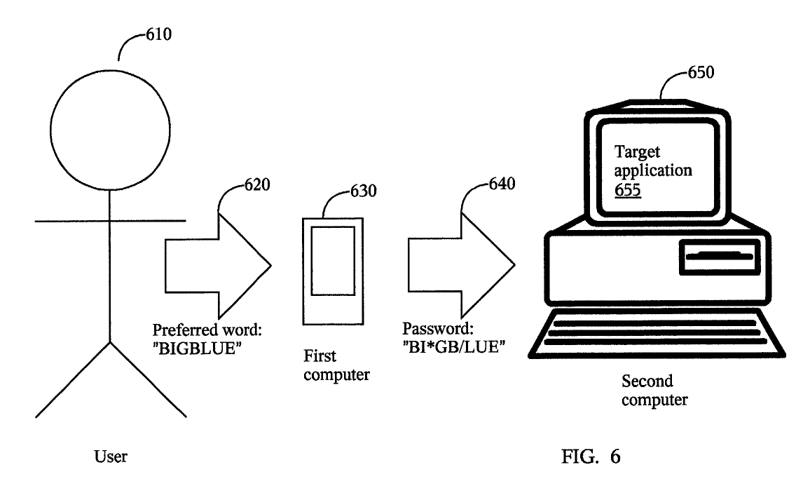

FIG. 6 is a diagram illustrating an example involving a first computer and a second computer, according to the teachings of the present invention. In this example, the translating is accomplished by software running on a first computer 630, and the target application 655 runs on a second computer 650. Through first computer 630, the password generator receives a preferred word, “BIGBLUE,” at 620, from a user 610. In this example, first computer 630 is shown as a handheld computer. The password generator also receives password format rules based on a rule set (not shown). The password generator translates the preferred word to produce a password, “BI*GB/LUE,” and provides, at 640, the password to a target application 655 running on second computer 650. The two computers may communicate via a serial port on second computer 650, for example, or via a wireless local area network using a standard such as Bluetooth or 802.11b.

Thus the translation of the user's preferred word may involve inserting at least one special character. The resulting password may not be easily predictable. In this example, a preferred word, “BIGBLUE,” is changed to “BI*GB/LUE.” Again, any special character that is recognizable by the target application could be used. As an alternative, the means for translating may include means for encrypting said preferred word.

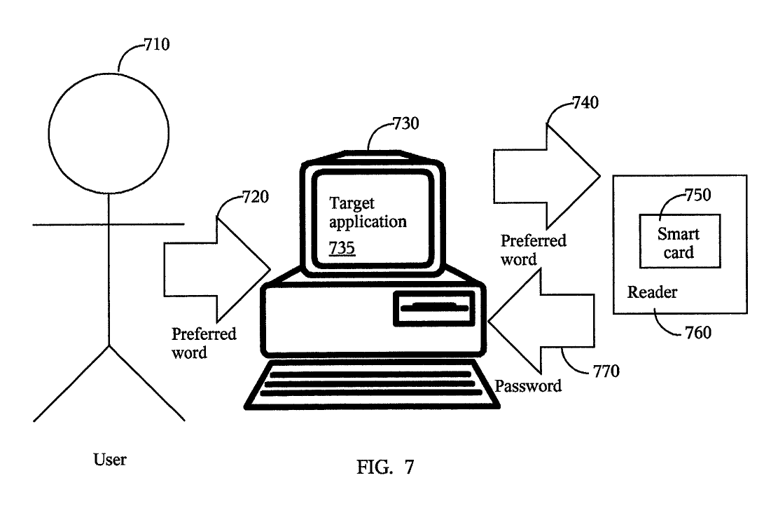

FIG. 7 is a diagram illustrating an example involving a smart card, according to the teachings of the present invention. In this example, translating is accomplished at least in part by a smart card 750. Through computer 730 and reader 760, the password generator running on smart card 750 receives a preferred word, at 720 and 740, from a user 710. The password generator also receives password format rules based on a rule set (not shown). The password generator translates the preferred word to produce a password, and provides, at 770, the password to a target application 735 running on computer 730. Again, the means for translating may include means for encrypting said preferred word.

One of the preferred implementations of the invention is an application, namely a set of instructions (program code) in a code module which may, for example, be resident in the random access memory of a computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer-usable medium having computer-executable instructions for use in a computer. In addition, although the various methods described are conveniently implemented in a general-purpose computer selectively activated or reconfigured by software, one of ordinary skill in the art would also recognize that such methods may be carried out in hardware, in firmware, or in more specialized apparatus constructed to perform the required method steps.

While the invention has been shown and described with reference to particular embodiments thereof, it will be understood by those skilled in the art that the foregoing and other changes in form and detail may be made therein without departing from the spirit and scope of the invention. The appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the appended claims may contain the introductory phrases “at least one” or “one or more” to introduce claim elements. However, the use of such phrases should not be construed to imply that the introduction of a claim element by indefinite articles such as “a” or “an” limits any particular claim containing such introduced claim element to inventions containing only one such element, even when the same claim includes the introductory phrases “at least one” or “one or more” and indefinite articles such as “a” or “an;” the same holds true for the use in the claims of definite articles.

I claim:

1. A method of generating a password, said method comprising:
receiving a preferred word from a user;
translating said preferred word to produce a password; and
providing said password to an application;
wherein
said preferred word is not stored;
said password is not stored; and
said password complies with said application's required password format.

2. The method of claim 1, wherein said translating includes encrypting said preferred word.

3. The method of claim 1, wherein said translating includes substituting a character for another character.

4. The method of claim 1, wherein said translating includes inserting at least one special character.

5. The method of claim 1, wherein said password is similar to said preferred word.

6. The method of claim 1, wherein
said translating is accomplished by software running on a first computer; and
said target application runs on a second computer.

7. The method of claim 1, wherein said translating is accomplished at least in part by a smart card.

8. The method of claim 1, wherein said translating is accomplished by software running on the same computer as said target application.

9. A method of generating a password, said method comprising:
receiving input from a user, specifying a target application;
receiving input from said user, specifying a password format;
receiving input from a user, specifying a preferred word;
in response to said inputs, translating said preferred word to produce a password; and
providing said password for use by said target application;
wherein
said preferred word is not stored;
said password is not stored; and
said password complies with said application's required password format.

10. The method of claim 9, wherein said translating includes encrypting said preferred word.

11. The method of claim 9, wherein said translating includes substituting a character for another character.

12. The method of claim 9, wherein said translating includes inserting at least one special character.

13. The method of claim 9, wherein said password is similar to said preferred word.

14. The method of claim 9, wherein
said translating is accomplished by software running on a first computer; and
said target application runs on a second computer.

15. The method of claim 9, wherein said translating is accomplished at least in part by a smart card.

16. The method of claim 9, wherein said translating is accomplished by software running on the same computer as said target application.

17. A system for generating a password, said system comprising:
means for receiving input from a user, specifying a target application;
means for receiving input from said user, specifying a password format;
means for receiving input from a user, specifying a preferred word;
means, responsive to said inputs, for translating said preferred word to produce a password; and
means for providing said password for use by said target application;
wherein
said preferred word is not stored;
said password is not stored; and
said password complies with said application's required password format.

18. The system of claim 17, wherein said means for translating includes means for encrypting said preferred word.

19. The system of claim 17, wherein said means for translating includes means for substituting a character for another character.

20. The system of claim 17, wherein said means for translating includes means for inserting at least one special character.

21. The system of claim 17, wherein said password is similar to said preferred word.

22. The system of claim 17, wherein said means for translating runs on a first computer; and said target application runs on a second computer.

23. The system of claim 17, wherein said means for translating includes a smart card.

24. The system of claim 17, wherein said means for translating runs on the same computer as said target application.

25. A computer-usable medium having computer-executable instructions for generating a password, said computer-executable instructions comprising:
means for receiving input from a user, specifying a target application;
means for receiving input from said user, specifying a password format;
means for receiving input from a user, specifying a preferred word;
means, responsive to said inputs, for translating said preferred word to produce a password; and
means for providing said password for use by said target application;
wherein
said preferred word is not stored;
said password is not stored; and
said password complies with said application's required password format.

26. The computer-usable medium of claim 25, wherein said means for translating includes means for encrypting said preferred word.

27. The computer-usable medium of claim 25, wherein said means for translating includes means for substituting a character for another character.

28. The computer-usable medium of claim 25, wherein said means for translating includes means for inserting at least one special character.

29. The computer-usable medium of claim 25, wherein said password is similar to said preferred word.

30. The computer-usable medium of claim 25, wherein said means for translating runs on a first computer; and said target application runs on a second computer.

31. The computer-usable medium of claim 25, wherein said means for translating includes a smart card.

32. The computer-usable medium of claim 25, wherein said means for translating runs on the same computer as said target application.
